(19) United States
(12) Patent Application Publication
(10) Pub. No.: US 2026/0203286 A1
(43) Pub. Date: Jul. 16, 2026

(54) KNOWLEDGE GRAPH QUERY OPTIMIZATION FOR RETRIEVAL AUGMENTED GENERATION

(71) Applicant: Microsoft Technology Licensing, LLC, Redmond, WA (US)

(72) Inventors: Evgeny MELNIKOV, Belgrade (RS); Jógvan Nikolaj KJØLBRO, Barcelona (ES)

(21) Appl. No.: 19/024,421

(22) Filed: Jan. 16, 2025

(51) Int. Cl. G06F 16/2453; G06F 16/25; G06F 16/953

(52) U.S. Cl. CPC G06F 16/24542; G06F 16/258; G06F 16/953

(57) ABSTRACT

Techniques are provided for improving chat response generation using knowledge graph-based data retrieval. A chat system receives a user message and identifies relevant entities by performing a web search. A first generative language model receives a prompt containing the chat history, identified entities, and a knowledge graph schema defining entity types and relationships. The first model generates a structured query targeting specific entity attributes in the knowledge graph. After executing the query to retrieve targeted entity data, a second generative language model receives the retrieved data and user message to generate a contextually relevant response. The system enables precise control over grounding data by using the knowledge graph schema to specify exactly which entity attributes to retrieve, avoiding excessive or irrelevant information while maintaining comprehensive responses. This approach improves upon conventional database solutions by allowing flexible, relationship-aware queries that retrieve diverse yet focused entity information based on conversational context.

### TECHNICAL FIELD

The present disclosure relates generally to retrieval augmented generation (RAG) systems for artificial intelligence (AI) chatbots, and more particularly to techniques for optimizing the retrieval and use of grounding data through knowledge graph implementations. Specifically, the disclosure describes approaches for using generative language models, such as large language models (LLMs), to generate targeted knowledge graph queries that enable precise and relevant data retrieval for chat response generation. The technical field encompasses AI, machine learning, and specifically the development of chat systems that can efficiently retrieve and utilize structured entity data while addressing challenges in data relevance, computational efficiency, and response quality.

### BACKGROUND

The field of artificial intelligence (AI) has witnessed rapid advancements, particularly in the domain of generative language models. Large language models (LLMs) are a specialized class of generative language model, and are characterized by their capacity to process and generate human-like text. LLMs have become pivotal in various applications, including natural language processing, content generation, and question answering. Despite their remarkable capabilities, these models face significant challenges in delivering consistent accuracy and efficiency when tasked with retrieving and synthesizing relevant information from large repositories of data.

Retrieval-Augmented Generation (RAG) techniques have emerged as a prominent approach to address these challenges. RAG combines retrieval mechanisms with generative capabilities, enabling LLMs to dynamically incorporate external knowledge into their outputs. In a typical RAG framework, a retrieval component, such as a search engine, identifies pertinent information from a content repository or knowledge base to serve as grounding data for the LLM. This grounding data provides factual context that the LLM can reference when generating responses. The LLM then synthesizes the grounding data into coherent, contextually relevant responses, maintaining accuracy by anchoring its output in the retrieved facts. This synergy between retrieval mechanisms and generative capabilities enhances the factual accuracy and domain-specific relevance of the output, making RAG techniques vital for applications that demand precision, such as legal analysis, medical diagnostics, technical support, and others.

### BRIEF DESCRIPTION OF THE DRAWINGS

Embodiments of the present invention are illustrated by way of example and not limitation in the figures of the accompanying drawings, in which:

FIGS. 1A, 1B and 1C illustrate problems with conventional chat response systems that use fixed context windows and rigid data structures, showing how search results and response quality are limited by token constraints and inflexible data formats, consistent with some embodiments.

FIG. 2 illustrates a system architecture for generating chat responses using knowledge graph queries, showing components for entity extraction, query generation, and response generation, consistent with some embodiments.

FIG. 3 illustrates a flowchart of operations for processing user messages to generate responses using knowledge graph queries, consistent with some embodiments.

FIG. 4 illustrates a user interface of a mobile device configured to display chat messages and responses, consistent with some embodiments.

FIG. 5 illustrates a software architecture that may be installed on a machine, consistent with some embodiments.

FIG. 6 illustrates a diagrammatic representation of a machine in the form of a computer system within which a set of instructions may be executed for causing the machine to perform any one or more of the methodologies discussed herein, consistent with some embodiments.

### DETAILED DESCRIPTION

Described herein are techniques for improving chat response generation using knowledge graph-based data retrieval for a chat system that leverages Retrieval-Augmented Generation (RAG). The methods and systems set forth herein enable precise control over grounding data by using large language models (LLMs) to generate targeted knowledge graph queries based on conversational context. Rather than relying on rigid database schemas or general web search results that may provide insufficient or excessive information, the disclosed approaches allow chatbots to selectively retrieve exactly the entity data needed to generate high-quality responses. In the following description, numerous specific details are provided, including techniques for entity extraction from search results, methods for generating structured knowledge graph queries, and approaches for using retrieved entity data to ground response generation. These details enable one skilled in the art to practice the disclosed embodiments. It will be apparent, however, to one skilled in the art that the disclosed embodiments may be practiced without these specific details.

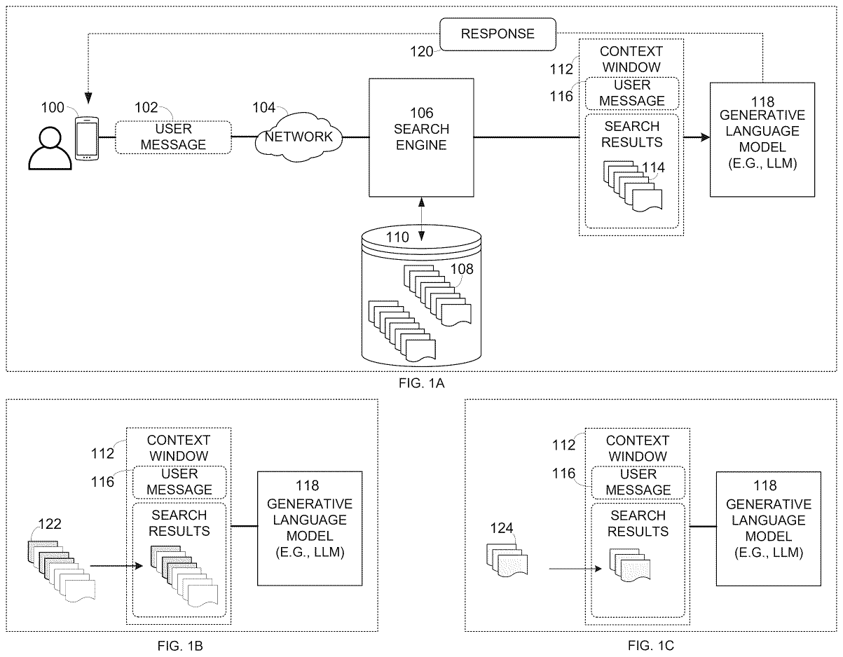

Conventional RAG-based systems face significant technical challenges in providing accurate and efficient responses to user queries. As illustrated in FIG. 1A, a conventional RAG system receives a user message 102, from a user device 100 over a network 104 and employs a content retrieval component, such as a search engine 106, to search a content repository 110 using keywords from the user message. The search results 114 are then provided within a context window 112 along with the user message 116 to a generative language model 118 to generate a response 120.

This conventional approach leads to two distinct technical problems, as depicted in FIGS. 1B and 1C. In FIG. 1B, the search results 122 include both relevant (shaded) and irrelevant (unshaded) documents. When all these results are included in the context window 112, it creates two technical issues: (1) the large volume of tokens consumes more computational resources, increases processing time, and ultimately increases costs, and (2) the presence of irrelevant information degrades response quality by introducing noise into the input provided to the generative language model.

Conversely, as shown in FIG. 1C, attempts to limit search results 124 to reduce token consumption often lead to incomplete or insufficient information being provided to the generative language model 118. This is particularly problematic when the chat history contains important context that should influence the selection of relevant information. The limited results may omit details needed to generate an accurate and comprehensive response. For example, in an effort to decrease the total number of tokens representing the grounding data, the search results may be limited to some small number of top-ranked results, such as the three highest ranked documents. This can result in poor quality responses as the most relevant information—that is, the information that best matches both the user message and the broader conversation context—may not be included within these top-ranked results, preventing the model from accessing crucial details needed for an accurate response.

These technical challenges stem from the fundamental limitations of conventional keyword-based search approaches, which cannot effectively balance the competing needs for comprehensive yet focused information retrieval. The search engine 106 either returns too much information, overwhelming the context window 112 and degrading model performance, or too little information, preventing the model from generating fully informed responses.

To solve the aforementioned technical problems, set forth herein is a novel approach that leverages knowledge graph-based data retrieval in combination with LLMs to enable precise and contextually relevant information retrieval for chat response generation. Rather than relying on conventional search results that provide either too much or too little information, the disclosed system uses a targeted, two-stage approach to retrieve exactly the entity data needed for generating high-quality responses.

In a first stage, the system identifies relevant entities by performing an initial web search using the user message. A named entity recognition model processes the initial search results to extract and classify entities according to types defined in a knowledge graph schema. This initial stage provides a foundation for understanding which entities are relevant to the user's query.

In a second stage, the system leverages a first generative language model, such as an LLM, to create a targeted knowledge graph query. This first generative language model receives a carefully constructed prompt containing the chat history, the previously identified entities, and a knowledge graph schema that defines available entity types and relationships. By considering both the conversational context and the structured schema, the model can generate queries that precisely specify which entity attributes and relationships should be retrieved.

The system maintains computational efficiency through several key mechanisms. First, by using targeted knowledge graph queries that precisely specify required entity attributes and relationships, the system retrieves only the most relevant data rather than entire document collections. This selective retrieval significantly reduces the token count compared to traditional approaches that include full documents in the context window. Second, the knowledge graph's structured format enables efficient traversal of entity relationships without processing redundant or irrelevant information. For example, when a user refines their query about restaurants to focus on price ranges, the system can directly retrieve pricing attributes without reprocessing other restaurant details. Finally, by maintaining entity data in a normalized, structured format within the knowledge graph, the system avoids the computational overhead of processing and deduplicating redundant entity information that often appears across multiple documents in conventional search results.

The knowledge graph queries enable selective retrieval of exactly the entity information needed for the current conversation context. Unlike conventional approaches that either overwhelm the context window with irrelevant data or provide insufficient information, the knowledge graph approach allows for precise specification of required entity attributes and relationships. This targeted retrieval ensures that only relevant data is provided to a second generative language model for response generation,

The retrieved entity data serves as grounding information for the second generative language model, which receives the data along with the user message, chat conversation history, and specific instructions for response generation. This approach ensures that responses are both comprehensive and focused, incorporating precisely the information needed while maintaining computational efficiency. Other aspects and advantages of the various embodiments will be readily apparent from the detailed descriptions of the several figures that follow.

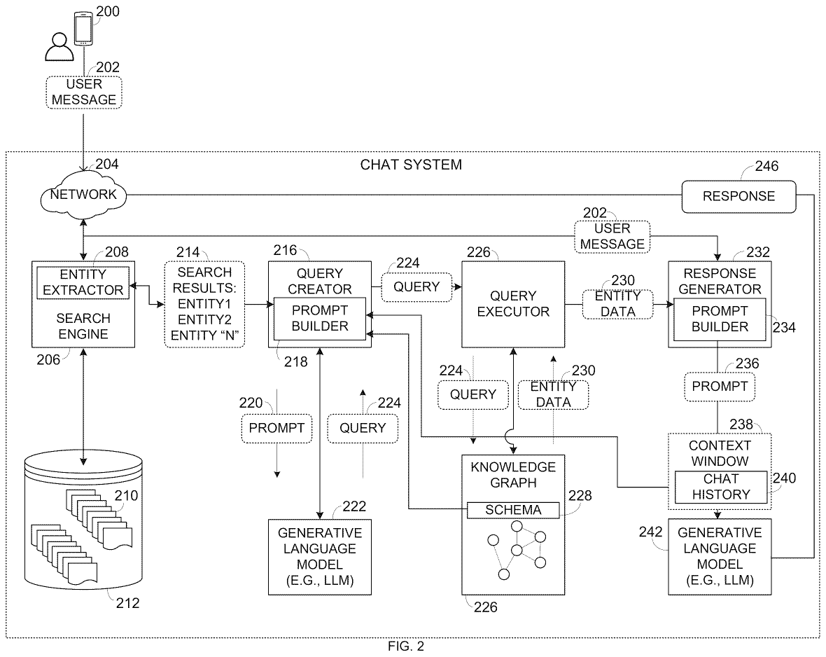

FIG. 2 illustrates a system architecture for generating chat responses using knowledge graph queries, showing components for entity extraction, query generation, and response generation, consistent with some embodiments. As illustrated in FIG. 2, a user interacts with the chat system using a client device 200 to send a user message 202 as part of an ongoing conversation. The user message 202 is transmitted over a network 204 to the chat-based system for processing.

Upon receiving the user message, a search engine 206 performs entity identification through one of multiple approaches, depending upon the implementation. In one embodiment, the search engine 206 searches web documents 210 stored in a database or other content repository 212 using various techniques. For example, the search engine 206 may employ traditional keyword-based indexing and matching techniques that identify documents containing terms from the user message. Alternatively, the search engine 206 may utilize semantic search capabilities that understand conceptual relationships between search terms, or may employ specialized domain-specific search algorithms optimized for particular types of entities like restaurants or businesses. The search engine 206 may also incorporate machine learning models trained to identify relevant documents based on patterns learned from historical search data, rather than relying solely on keyword matching.

In another embodiment, the search engine 206 maintains one or more entity indices that directly store and index entities and their attributes according to the knowledge graph schema 228. This approach allows the search engine to efficiently identify relevant entities by searching pre-indexed entity information rather than extracting entities from documents at query time. The entity indices may contain normalized entity attributes, relationships between entities, and other structured data that aligns with the knowledge graph schema.

When using the document-based approach, the search results are analyzed by an entity extractor 208 to identify and extract relevant entities. In this context, an entity refers to a distinct object or concept that can be uniquely identified and described, such as a restaurant, business, product, or location. The entity extractor 208 employs a named entity recognition model configured to detect and classify entity mentions within the search results according to entity types defined in the knowledge graph schema. The entity extraction process involves analyzing the search results to detect entity mentions, extract contextual attributes associated with each detected entity, and normalize the extracted entities and attributes to a standardized format compatible with the knowledge graph schema 228. The entity extractor 208 may also resolve entity ambiguities using extracted contextual information to ensure accurate entity identification.

In various embodiments, regardless of whether entities are identified through document extraction or direct indexing, the system may be configured to identify and retrieve entities specific to different application domains. For example, in a restaurant recommendation domain, entities may include restaurants, menu items, cuisines, and locations, while in a retail domain, entities may include products, stores, brands, and inventory information. Similarly, in a travel domain, relevant entities might include hotels, attractions, transportation options, and events, while a healthcare domain would focus on medical facilities, practitioners, treatments, and conditions.

The domain-specific nature of entity identification or extraction enables the system to be adapted for diverse use cases while maintaining precise and relevant entity identification. For example, when deployed in a financial services context, the search engine may search for documents that have been indexed in part based on entities relevant to financial services. Alternatively, the entity extractor 208 may be specifically trained to recognize and classify entities such as financial products, institutions, market indicators, and transaction types. In a real estate implementation, the system may focus on properties, neighborhoods, amenities, and market trends.

This domain-specific approach allows the search engine 206 to retrieve entities associated with a specific domain that are also relevant to the user message, or in some alternative embodiments, the entity extractor 208 to leverage specialized named entity recognition models that are optimized for the particular vocabulary, relationships, and attributes relevant to each domain. The extracted entities are then normalized according to the corresponding domain-specific knowledge graph schema 228, ensuring that subsequent query generation and response creation maintain domain-appropriate context and accuracy.

The extracted entities 214 are then communicated to a query creator component 216 for further processing. These entities 214 serve as a foundation for generating targeted knowledge graph queries that will retrieve precisely relevant information based on the conversation context.

Consistent with some embodiments, the query creator 216 includes a prompt builder 218 that receives three separate inputs to generate a structured knowledge graph query. First, the query creator 216 receives the entities 214 identified by the entity extractor 208 from the initial search results. Second, the query creator 216 obtains or receives the knowledge graph schema 228 which defines the available entity types, attributes, and relationships that can be queried. Third, the query creator 216 obtains or receives the chat history 240 which provides conversational context for determining which entity attributes are most relevant to the current interaction.

Using these three inputs, the prompt builder 218 generates a prompt 220 that is provided to a generative language model 222. The prompt includes specific instructions directing the generative language model 222 to analyze the chat history and identified entities in the context of the knowledge graph schema 228, and to generate a structured query 224 that will be used to retrieve the most relevant entity data from the knowledge graph 226.

The prompt builder 218 structures the prompt 220 to ensure the generative language model 222 considers both the immediate user message context as well as the broader conversation history when determining which entity attributes and relationships to include in the query. This enables the system to generate highly targeted queries that retrieve precisely the entity data needed to provide an accurate and contextually appropriate response.

For example, if the chat history indicates a user's interest in restaurant pricing and hours, the generated query will specifically request those attributes for relevant restaurant entities, rather than retrieving all available entity data. This targeted approach helps avoid both information overload and missing context issues that plague conventional approaches.

Consistent with some embodiments, the prompt builder 218 may employ a template-based approach to structure prompts for the generative language model 222. In this implementation, the system maintains a collection of prompt templates designed for different conversation scenarios and entity types. Each template contains placeholders for inserting the chat history, identified entities, and relevant portions of the knowledge graph schema. For example, a restaurant-focused template might include sections for incorporating price ranges, operating hours, and location data, while a retail-focused template would emphasize inventory, product specifications, and store locations.

In other embodiments, the prompt builder 218 may utilize a dynamic prompt construction approach. This implementation analyzes the chat history 240 and identified entities to determine the most relevant attributes and relationships needed for the current conversation context. The prompt builder then generates a customized prompt structure that emphasizes these elements, potentially incorporating specific instructions about which entity attributes should be prioritized in the knowledge graph query. For example, when the conversation history indicates a focus on comparing prices across multiple restaurants, the prompt builder would dynamically construct a prompt that emphasizes menu item costs and price range attributes.

The prompt builder 218 may also implement a hybrid approach that combines template-based and dynamic construction methods. This implementation starts with a base template appropriate for the general conversation domain, then dynamically modifies and extends the template based on specific contextual needs. For instance, a restaurant template might be dynamically augmented with additional sections for dietary restrictions or delivery options if the chat history indicates these are relevant to the current conversation.

Consistent with some embodiments, the first generative language model undergoes specialized fine-tuning to generate structured knowledge graph queries. The fine-tuning process involves providing the generative language model 222 with carefully constructed training examples that demonstrate the desired input-output behavior. Each training example comprises an input prompt containing sample chat histories and entity information, paired with a corresponding output showing a properly formatted knowledge graph query that conforms to the knowledge graph schema 228.

In various embodiments, the fine-tuning process iteratively trains the generative language model 222 to recognize and properly utilize the structure of the knowledge graph schema. This includes learning to identify different types of entities (such as restaurants, menu items, and locations), understand valid relationships between these entities (such as has_menu, located_near, and serves_cuisine), and recognize appropriate attribute constraints for each entity type (such as valid price ranges, operating hours, and rating scales).

During the training process, consistent with some embodiments, the generative learning model is trained to analyze conversational context to determine relevant entity attributes and relationships. For example, when processing a user query about restaurant prices, the model learns to generate queries that include menu item costs and price range attributes. Conversely, when handling location-based inquiries, the model generates queries focusing on geographical relationships, distance calculations, and address information.

The fine-tuning process may incorporate comprehensive validation procedures to ensure generated queries maintain proper structure and compatibility with the knowledge graph schema 228. This validation encompasses verifying that referenced entity types exist within the schema 228, confirming requested attributes are valid for the specified entity types, ensuring relationship patterns align with defined schema constraints, and validating that query syntax follows the required format specifications.

In some embodiments, the resulting fine-tuned generative language model 222 demonstrates the capability to generate queries that precisely specify which entity attributes to retrieve based on conversational context, while maintaining strict adherence to the knowledge graph's structural requirements. This enables efficient retrieval of exactly the information needed for generating high-quality responses, thereby optimizing both computational resource usage and response relevance.

Consistent with some embodiments, the query executor 226 receives structured queries 224 from the query creator 216 and executes them against the knowledge graph 226 to retrieve precisely targeted entity data 230. Unlike conventional keyword-based approaches that search indexed documents, the query executor traverses the graph structure according to the relationships and constraints specified in the query.

The knowledge graph 226 stores information in a structured format where entities are represented as nodes with defined attributes and explicit relationships between them. When executing a query, the query executor 226 can follow these relationship edges to retrieve connected entity information, such as menu items associated with a restaurant or reviews linked to a business.

In some embodiments, the query executor 226 processes structured queries that specify exactly which entity types to retrieve, what attributes are needed for each entity, and what relationship constraints must be satisfied. This enables selective retrieval of only the most relevant data fields, avoiding the information overload problems that occur when searching unstructured document repositories.

The retrieved entity data 230 maintains its structured nature, organized according to the knowledge graph schema 228, providing several advantages over keyword-based document search. By enabling precise attribute selection, the system reduces irrelevant data retrieval while allowing relationship traversal to discover contextually connected entities. The schema conformance ensures consistent data organization throughout the response generation process, enabling more accurate and focused responses while maintaining computational efficiency.

Consistent with some embodiments, the response generator 232 receives both the entity data 230 from the query executor 226 and the original user message 202 as inputs. The prompt builder 234 processes these inputs along with the chat history 240 to generate a response prompt 236, employing various techniques such as template-based approaches where predefined prompt structures are populated with the retrieved entity data, user message, and relevant conversation context.

In some embodiments, rather than explicitly including the full chat history in the prompt 236, the prompt builder 234 relies on the context window 238 to maintain conversational context. This approach allows the generative language model 242 to access relevant portions of the chat history 240 as needed while generating the response, without increasing the size of the prompt itself. The context window 238 provides an efficient mechanism for the model to reference previous exchanges and maintain coherence across the conversation.

The prompt builder 234 formats the entity data into a structured representation that clearly delineates different entity types, attributes, and relationships, while incorporating the specific user message 202 to provide context for the response generation task. The prompt 236 includes specific instructions directing the generative language model 242 how to incorporate both the entity data and user message when generating the response, such as prioritizing certain attributes based on the conversation context maintained in the context window 238.

Through this architecture, the response generator 232 maintains conversational coherence by allowing the generative language model 242 to access both the immediate context provided by the prompt 236 and the broader conversation history available through the context window 238. This enables the generation of responses that are both immediately relevant to the user message 202 and consistent with the overall conversation flow, while efficiently managing computational resources by avoiding redundant inclusion of chat history in the prompt itself.

The response 246 generated by the generative language model 242 is then transmitted back to the user device 200 over the network 204. This structured approach to response generation ensures that responses are both comprehensive and focused, incorporating precisely the entity information needed while maintaining natural conversational flow, Consistent with some embodiments, the various components of the system illustrated in FIG. 2 may be distributed across different computing resources and environments, and connected via one or more computer networks, including the network with reference 204. For example, the entity extractor 208 and search engine 206 may be hosted on dedicated search infrastructure, while the knowledge graph 226 and query executor 224 may reside in a separate cloud-based graph database environment.

The generative language models 222 and 242 may be accessed as remote services through API calls to cloud-based LLM providers, enabling the system to leverage state-of-the-art language models without maintaining local model infrastructure. In some embodiments, the prompt builders 218 and 234 may be implemented as serverless functions that dynamically construct prompts based on the current system state and requirements.

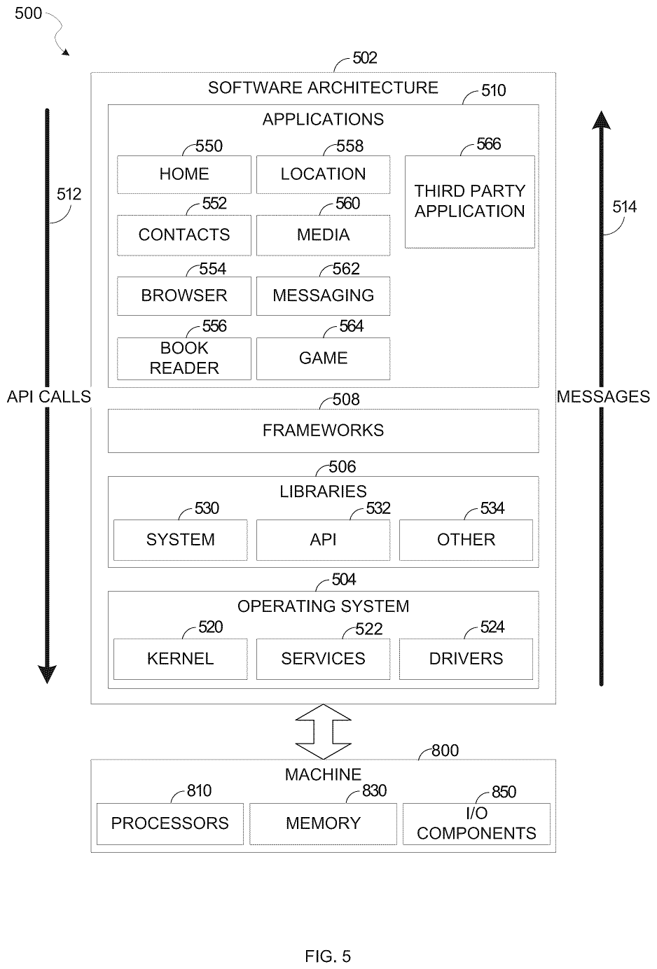

The software architecture 500 illustrated in FIG. 5 demonstrates how the system components may be organized across different layers, from applications 510 down to the operating system 504 and machine hardware 800. This layered architecture enables flexible deployment options, where components can be distributed across multiple machines or consolidated based on scaling needs and resource availability.

In various embodiments, the knowledge graph 226 may be implemented using different graph database technologies and hosted in various configurations, from dedicated graph database clusters to managed cloud services. The schema 228 may be replicated across multiple instances to ensure high availability while maintaining consistency of entity definitions and relationships.

In various embodiments, while the generative language models 222 and 242 illustrated in FIG. 2 may be implemented as LLMs, the system may alternatively employ specialized language models with different parameter counts and model architectures. These specialized models may be technically classified as medium or small language models based on their number of parameters, while still maintaining the capability to generate knowledge graph queries and chat responses within their specific domains. The selection of model size and architecture may be optimized based on factors such as computational resources, response time requirements, and the complexity of the knowledge domain being addressed. For example, a specialized model trained specifically on restaurant entity data and conversational patterns may achieve high performance with fewer parameters than a general-purpose LLM.

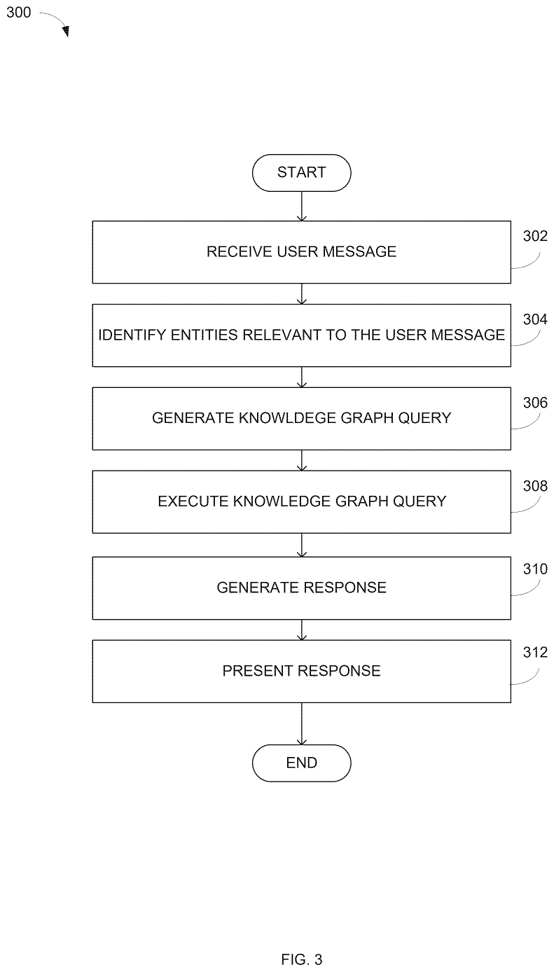

FIG. 3 illustrates a flowchart of operations for processing user messages to generate responses using knowledge graph queries, consistent with some embodiments.

At operation 302, a user interacts with the chat system via a client device 200 to send a message. The chat system receives the user message 202 over a network 204, where the message may be part of an ongoing conversation maintained in chat history 240.

Operation 304 involves identifying relevant entities through multiple approaches. In one embodiment, the search engine 206 first performs a search of web documents 210 using keywords from the user message, and the entity extractor 208 then employs a named entity recognition model to analyze the search results and detect entity mentions. This model is specifically configured to classify entities according to types defined in the knowledge graph schema 228, extract contextual attributes, and normalize the entities to a standardized format.

In another embodiment, the search engine 206 maintains one or more search indices that directly index entities and their attributes according to the knowledge graph schema 228. Rather than extracting entities from web documents at query time, this approach allows the search engine to efficiently return relevant entity data in response to the user message by searching the pre-indexed entity information. The search indices may store normalized entity attributes, relationships between entities, and other structured data that aligns with the knowledge graph schema. This enables rapid identification of relevant entities while maintaining consistency with the knowledge graph structure. The indexed entities can be periodically updated to reflect changes in the underlying entity data, ensuring the search results remain current and accurate.

In operation 306, the system generates a knowledge graph query through a specialized process. The prompt builder 218 constructs a prompt containing the chat history, identified entities, and knowledge graph schema. This prompt is provided to a first generative language model 222 that has been fine-tuned through iterative training to recognize schema structures and generate valid queries. The model learns to analyze conversational context to determine which entity attributes and relationships are most relevant.

Operation 308 executes the generated query against the knowledge graph 226. The query executor processes structured queries that precisely specify entity types, attributes, and relationship constraints to retrieve. This enables selective retrieval of only the most relevant data fields while maintaining the structured nature of the knowledge graph format.

For operation 310, the response generator 232 receives both the entity data 230 and original user message 202. The prompt builder 234 constructs a prompt containing specific instructions for generating a response, formatting the entity data into a structured representation. The second generative language model 242 receives this prompt along with access to the context window 238 containing chat history, enabling it to maintain conversational coherence while incorporating the retrieved entity data.

Finally, in operation 312, the generated response 246 is transmitted back to the user device 200 over the network 204. The response incorporates the retrieved entity data in a natural language format while maintaining factual accuracy and contextual relevance to both the immediate query and broader conversation.

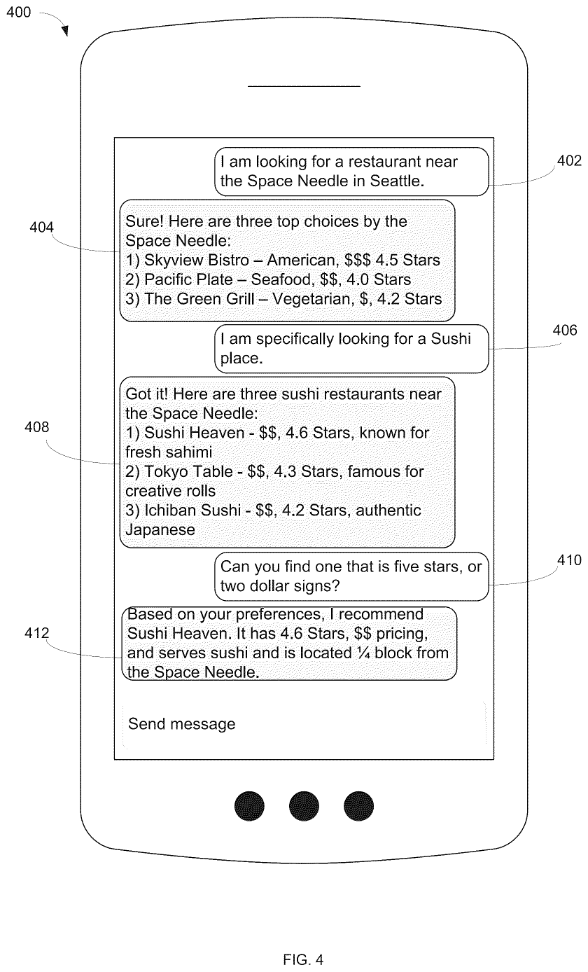

FIG. 4 illustrates a chat interface 400 showing an example conversation between a user and the chat system that demonstrates the ability of the chat system to process contextual queries and generate targeted responses using knowledge graph data.

The conversation begins with the user sending message 402 requesting restaurants near the Space Needle. The system processes this initial query by extracting location and restaurant entities, generating a knowledge graph query to retrieve relevant restaurant data, and providing response 404 with three restaurant options, including key attributes like cuisine type, price range (using $ symbols), and star ratings.

When the user sends message 406 specifying a preference for sushi restaurants, the system maintains the location context from the previous exchange while generating a new knowledge graph query focused on sushi restaurants. Response 408 demonstrates how the system retrieves and presents detailed entity data including ratings, price levels, and distinguishing features of each sushi restaurant.

The user further refines their preferences in message 410, asking about five-star or two-dollar-sign restaurants. The system analyzes this request against the previously retrieved entity data and generates response 412 recommending Sushi Heaven, incorporating precise location data (“¼ block from the Space Needle”) along with the specifically requested attributes (4.6 Stars, $$ pricing).

This conversation flow demonstrates how the system maintains context across multiple exchanges while leveraging the knowledge graph to retrieve increasingly specific and relevant entity data based on evolving user preferences. The responses show how the system can format entity data into natural language responses while preserving factual accuracy and incorporating appropriate context from the conversation history.

While the examples presented herein often describe the AI-based chat system in the context of restaurant search and recommendations, this is merely one illustrative application of the disclosed techniques. The knowledge graph-based retrieval system may be adapted for diverse domains and use cases. For example, in a retail context, the system may process queries about products, inventory, and store locations, while in a healthcare domain it could handle inquiries about medical facilities, practitioners, and treatments. The ability of the chat system to maintain contextual awareness and generate targeted queries applies equally well across financial services, real estate, travel, and numerous other domains.

The disclosed techniques provide several key technical advantages over conventional approaches. First, by using a knowledge graph with a well-defined schema, the system enables precise control over what information is retrieved, avoiding both the information overload that degrades response quality and the insufficient context that leads to incomplete answers. This targeted retrieval optimizes computational resource usage by including only relevant data in the context window.

Second, the use of fine-tuned language models to generate structured knowledge graph queries represents a significant improvement over rigid database schemas or keyword-based searches. The models can analyze conversation context to determine exactly which entity attributes and relationships are relevant, enabling flexible and precise data retrieval that adapts to the user's specific needs. This approach maintains high response quality while efficiently managing computational resources.

Finally, the ability of the chat system to maintain conversational context through the context window while selectively retrieving relevant entity data enables more natural and accurate responses. Unlike conventional systems that either overwhelm the model with irrelevant data or miss crucial context, this approach ensures responses are both comprehensive and focused, incorporating exactly the information needed to address the user's query.

### Machine and Software Architecture

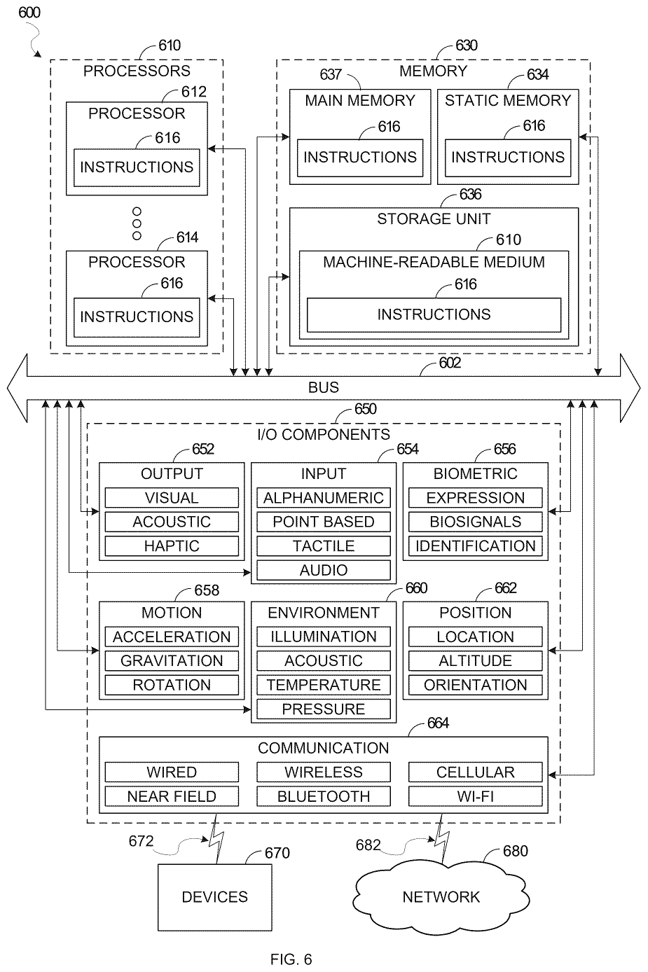

FIG. 5 is a block diagram 500 illustrating a software architecture 502, which can be installed on any of a variety of computing devices to perform methods consistent with those described herein. FIG. 5 is merely a non-limiting example of a software architecture, and it will be appreciated that many other architectures can be implemented to facilitate the functionality described herein. In various embodiments, the software architecture 502 is implemented by hardware such as a machine 600 of FIG. 6 that includes processors 610, memory 630, and input/output (I/O) components 650. In this example architecture, the software architecture 502 can be conceptualized as a stack of layers where each layer may provide a particular functionality. For example, the software architecture 502 includes layers such as an operating system 504, libraries 506, frameworks 508, and applications 510. Operationally, the applications 510 invoke API calls 512 through the software stack and receive messages 514 in response to the API calls 512, consistent with some embodiments.

In various embodiments, the operating system 504 manages hardware resources and provides common services. The operating system 504 includes, for example, a kernel 520, services 522, and drivers 524. The kernel 520 acts as an abstraction layer between the hardware and the other software layers, consistent with some embodiments. For example, the kernel 520 provides memory management, processor management (e.g., scheduling), component management, networking, and security settings, among other functionality. The services 522 can provide other common services for the other software layers. The drivers 524 are responsible for controlling or interfacing with the underlying hardware, according to some embodiments. For instance, the drivers 524 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 506 provide a low-level common infrastructure utilized by the applications 510. The libraries 506 can include system libraries 530 (e.g., C standard library) that can provide functions such as memory allocation functions, string manipulation functions, mathematic functions, and the like. In addition, the libraries 506 can include API libraries 532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 506 can also include a wide variety of other libraries 534 to provide many other APIs to the applications 510.

The frameworks 508 provide a high-level common infrastructure that can be utilized by the applications 510, according to some embodiments. For example, the frameworks 508 provide various GUI functions, high-level resource management, high-level location services, and so forth. The frameworks 508 can provide a broad spectrum of other APIs that can be utilized by the applications 510, some of which may be specific to a particular operating system 504 or platform.

In an example embodiment, the applications 510 include a home application 550, a contacts application 552, a browser application 554, a book reader application 556, a location application 558, a media application 560, a messaging application 562, a game application 564, and a broad assortment of other applications, such as a third-party application 566. According to some embodiments, the applications 510 are programs that execute functions defined in the programs. Various programming languages can be employed to create one or more of the applications 510, structured in a variety of manners, such as object-oriented programming languages (e.g., Objective-C, Java, or C++) or procedural programming languages (e.g., C or assembly language). In a specific example, the third-party application 566 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 566 can invoke the API calls 512 provided by the operating system 504 to facilitate functionality described herein.

FIG. 6 illustrates a diagrammatic representation of a machine 600 in the form of a computer system within which a set of instructions may be executed for causing the machine to perform any one or more of the methodologies discussed herein, according to an example embodiment. Specifically, FIG. 6 shows a diagrammatic representation of the machine 600 in the example form of a computer system, within which instructions 616 (e.g., software, a program, an application, an applet, an app, or other executable code) for causing the machine 600 to perform any one or more of the methodologies discussed herein may be executed. For example the instructions 616 may cause the machine 600 to execute any one of the methods or algorithmic techniques described herein. Additionally, or alternatively, the instructions 616 may implement any one of the systems described herein. The instructions 616 transform the general, non-programmed machine 600 into a particular machine 600 programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 616, sequentially or otherwise, that specify actions to be taken by the machine 600. Further, while only a single machine 600 is illustrated, the term “machine” shall also be taken to include a collection of machines 600 that individually or jointly execute the instructions 616 to perform any one or more of the methodologies discussed herein.

The machine 600 may include processors 610, memory 630, and I/O components 650, which may be configured to communicate with each other such as via a bus 602. In an example embodiment, the processors 610 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 612 and a processor 614 that may execute the instructions 616. The term “processor” is intended to include multi-core processors that may comprise two or more independent processors (sometimes referred to as “cores”) that may execute instructions contemporaneously. Although FIG. 6 shows multiple processors 610, the machine 600 may include a single processor with a single core, a single processor with multiple cores (e.g., a multi-core processor), multiple processors with a single core, multiple processors with multiples cores, or any combination thereof.

The memory 630 may include a main memory 632, a static memory 634, and a storage unit 636, all accessible to the processors 610 such as via the bus 602. The main memory 630, the static memory 634, and storage unit 636 store the instructions 616 embodying any one or more of the methodologies or functions described herein. The instructions 616 may also reside, completely or partially, within the main memory 632, within the static memory 634, within the storage unit 636, within at least one of the processors 610 (e.g., within the processor's cache memory), or any suitable combination thereof, during execution thereof by the machine 600.

The I/O components 650 may include a wide variety of components to receive input, provide output, produce output, transmit information, exchange information, capture measurements, and so on. The specific I/O components 650 that are included in a particular machine will depend on the type of machine. For example, portable machines such as mobile devices will likely include a touch input device or other such input mechanisms, while a headless server machine will likely not include such a touch input device. It will be appreciated that the I/O components 650 may include many other components that are not shown in FIG. 6. The I/O components 650 are grouped according to functionality merely for simplifying the following discussion and the grouping is in no way limiting. In various example embodiments, the I/O components 650 may include output components 652 and input components 654. The output components 652 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 654 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 650 may include biometric components 656, motion components 658, environmental components 660, or position components 662, among a wide array of other components. For example, the biometric components 656 may include components to detect expressions (e.g., hand expressions, facial expressions, vocal expressions, body gestures, or eye tracking), measure bio-signals (e.g., blood pressure, heart rate, body temperature, perspiration, or brain waves), identify a person (e.g., voice identification, retinal identification, facial identification, fingerprint identification, or electroencephalogram-based identification), and the like. The motion components 658 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 662 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 650 may include communication components 664 operable to couple the machine 600 to a network 680 or devices 670 via a coupling 682 and a coupling 672, respectively. For example, the communication components 664 may include a network interface component or another suitable device to interface with the network 680. In further examples, the communication components 664 may include wired communication components, wireless communication components, cellular communication components, Near Field Communication (NFC) components, Bluetooth® components (e.g., Bluetooth® Low Energy), Wi-Fi@ components, and other communication components to provide communication via other modalities. The devices 670 may be another machine or any of a wide variety of peripheral devices (e.g., a peripheral device coupled via a USB).

Moreover, the communication components 664 may detect identifiers or include components operable to detect identifiers. For example, the communication components 664 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 664, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 630, 632, 634, and/or memory of the processor(s) 610) and/or storage unit 636 may store one or more sets of instructions and data structures (e.g., software) embodying or utilized by any one or more of the methodologies or functions described herein. These instructions (e.g., the instructions 616), when executed by processor(s) 610, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 680 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 680 or a portion of the network 680 may include a wireless or cellular network, and the coupling 682 may be a Code Division Multiple Access (CDMA) connection, a Global System for Mobile communications (GSM) connection, or another type of cellular or wireless coupling. In this example, the coupling 682 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 616 may be transmitted or received over the network 680 using a transmission medium via a network interface device (e.g., a network interface component included in the communication components 664) and utilizing any one of a number of well-known transfer protocols (e.g., HTTP). Similarly, the instructions 616 may be transmitted or received using a transmission medium via the coupling 672 (e.g., a peer-to-peer coupling) to the devices 670. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 616 for execution by the machine 600, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A method for generating a response in a chat system, the method comprising:
receiving a user message;
identifying a plurality of entities relevant to the user message by:
providing at least the user message as an input query to a search engine, and
receiving, from the search engine, search results identifying the plurality of entities;
generating a first prompt to be provided as input to a first generative language model, the first prompt comprising:
a chat history including the user message,
the identified plurality of entities, and
a knowledge graph schema defining entity types and relationships for a knowledge graph;
providing the first prompt as input to the first generative language model and receiving in response a structured query for retrieving data from the knowledge graph;
executing the structured query against the knowledge graph to retrieve graph-based entity data;
generating a second prompt to be provided as input to a second generative language model, the second prompt comprising:
an instruction to generate a response to the user message,
the user message, and
the retrieved graph-based entity data;
providing the second prompt to a second generative language model and receiving in response the response to the user message; and
causing the response to be presented.

2. The method of claim 1, wherein the first generative language model is fine-tuned to:
receive as input a chat history, entity information, and a knowledge graph schema, and
output structured queries compatible with the knowledge graph schema.

3. The method of claim 2, wherein fine-tuning the first generative language model comprises:
providing a plurality of training examples to the first generative language model, the training examples comprising:
input prompts containing sample chat histories, entity information, and the knowledge graph schema; and
corresponding output examples of structured queries conforming to a format consistent with the knowledge graph schema;
iteratively training the first generative language model using the plurality of training examples to:
recognize entity types and relationships defined in the knowledge graph schema;
identify relevant entity attributes based on conversational context; and
generate syntactically valid queries that specify only contextually relevant entity attributes and relationships; and
validating the generated queries against the knowledge graph schema to ensure proper structure and compatibility.

4. The method of claim 1, wherein identifying the plurality of entities comprises:
maintaining one or more search indices containing:
indexed web documents, and
indexed entities having attributes and relationships defined according to the knowledge graph schema;
performing a search using terms extracted from the user message to identify:
relevant web documents from the indexed web documents, and
relevant entities from the indexed entities; and
returning search results containing:
references to the relevant web documents, and
the relevant entities with their corresponding attributes and relationships.

5. The method of claim 4, wherein identifying the plurality of entities further comprises:
receiving the search results containing references to entities from the keyword-based search;
analyzing the search results using a named entity recognition model configured to:
detect and classify entity mentions within the indexed web documents according to entity types defined in the knowledge graph schema;
extract contextual attributes associated with each detected entity mention; and
normalize the extracted entity mentions and attributes to a standardized format; and
mapping the normalized entity mentions to corresponding entity identifiers in the knowledge graph by comparing extracted entity attributes against known entity attributes in the knowledge graph and resolving entity ambiguities using the extracted contextual attributes; and
generating entity identifier mappings for entities that match nodes in the knowledge graph.

6. The method of claim 1, wherein executing the structured query against the knowledge graph comprises:
receiving the structured query specifying entity types to retrieve, specific attributes each entity type, and relationship constraints between entities;
traversing the knowledge graph according to the specified relationships; and
returning only the specified attributes for matching entities.

7. The method of claim 1, wherein the knowledge graph schema defines:
hierarchical relationships between entity types;
attribute constraints for each entity type; and
valid relationship types between different entity classes.

8. The method of claim 1, wherein generating the second prompt comprises:
formatting the retrieved graph-based entity data into a structured format;
including context from the chat history relevant to the user message; and
specifying response constraints based on available entity attributes.

9. The method of claim 1, wherein the second prompt includes:
explicit instructions for response format and style;
relevant portions of chat history providing context; and
structured entity data organized by relationship type.

10. The method of claim 1, wherein the instruction included in the second prompt directs the second generative language model to:
analyze entity relationships defined in the retrieved graph-based data by identifying connections between entity nodes;
select entity attributes relevant to a context associated with the user message based on the identified relationships; and
compose a natural language response incorporating the selected attributes while maintaining factual accuracy of the entity data.

11. The method of claim 1, wherein the structured query specifies:
primary entity types matching an intent of the user message;
secondary related entities within a defined relationship distance; and
filtering criteria for entity attributes.

12. The method of claim 1, wherein the response generated by the second generative language model comprises a natural language description incorporating facts extracted from the graph-based entity data, organized according to contextually relevant patterns, and presented in a format appropriate to a context associated with the user message.

13. The method of claim 1, wherein the knowledge graph comprises:
entity nodes storing core attribute data;
relationship edges defining connections between entities; and
metadata describing entity and relationship types.

14. The method of claim 1, wherein the second generative language model generates the response by:
identifying primary and secondary entities in the graph-based data;
determining relevant attributes based on conversation context; and
composing a natural language response incorporating the determined attributes.

15. The method of claim 1, wherein the retrieved graph-based entity data comprises:
entity information including name, address, and contact details;
related entity information connected through knowledge graph relationships; and
contextual attributes including ratings, reviews and operational data.

16. A system for generating a response in a chat system, the system comprising:
one or more processors; and
one or more memory storage devices storing instructions that, when executed by the one or more processors, cause the system to perform operations comprising:
receiving a user message;
identifying a plurality of entities relevant to the user message by:
providing at least the user message as an input query to a search engine, and
receiving, from the search engine, search results identifying the plurality of entities;
generating a first prompt to be provided as input to a first generative language model, the first prompt comprising:
a chat history including the user message,
the identified plurality of entities, and
a knowledge graph schema defining entity types and relationships for a knowledge graph;
providing the first prompt as input to the first generative language model and receiving in response a structured query for retrieving data from the knowledge graph;
executing the structured query against the knowledge graph to retrieve graph-based entity data;
generating a second prompt to be provided as input to a second generative language model, the second prompt comprising:
an instruction to generate a response to the user message,
the user message, and
the retrieved graph-based entity data;
providing the second prompt to a second generative language model and receiving in response the response to the user message; and
causing the response to be presented.

17. The system of claim 16, wherein the first generative language model is fine-tuned to:
receive as input a chat history, entity information, and a knowledge graph schema, and
output structured queries compatible with the knowledge graph schema.

18. The system of claim 17, wherein fine-tuning the first generative language model comprises:
providing a plurality of training examples to the first generative language model, the training examples comprising:
input prompts containing sample chat histories, entity information, and the knowledge graph schema; and
corresponding output examples of structured queries conforming to a format consistent with the knowledge graph schema;
iteratively training the first generative language model using the plurality of training examples to:
recognize entity types and relationships defined in the knowledge graph schema;
identify relevant entity attributes based on conversational context; and
generate syntactically valid queries that specify only contextually relevant entity attributes and relationships; and
validating the generated queries against the knowledge graph schema to ensure proper structure and compatibility.

19. The system of claim 16, wherein identifying the plurality of entities comprises:
maintaining one or more search indices containing indexed web documents;
performing a keyword-based search of the indexed web documents using terms extracted from the user message; and
returning search results containing references to the plurality of entities.

20. A non-transitory computer-readable storage medium storing instructions that, when executed by one or more processors of a computing system, cause the computing system to perform operations comprising:
receiving a user message;
identifying a plurality of entities relevant to the user message by:
providing at least the user message as an input query to a search engine, and
receiving, from the search engine, search results identifying the plurality of entities;
generating a first prompt to be provided as input to a first generative language model, the first prompt comprising:
a chat history including the user message,
the identified plurality of entities, and
a knowledge graph schema defining entity types and relationships for a knowledge graph;
providing the first prompt as input to the first generative language model and receiving in response a structured query for retrieving data from the knowledge graph;
executing the structured query against the knowledge graph to retrieve graph-based entity data;
generating a second prompt to be provided as input to a second generative language model, the second prompt comprising:
an instruction to generate a response to the user message,
the user message, and
the retrieved graph-based entity data;
providing the second prompt to a second generative language model and receiving in response the response to the user message; and
causing the response to be presented.
